(19) United States
(12) Patent Application Publication
(10) Pub. No.: US 2013/0223796 A1
(43) Pub. Date: Aug. 29, 2013

(54) ARRAYED WAVELENGTH GRATING ROUTER (AWGR) FOR WAVELENGTH MULTIPLEXING AND DEMULTIPLEXING

(71) Applicants: Sil-Gu MUN, Daejeon-si (KR); Jeong-Sik CHO, Daejeon-si (KR); Eun-Gu LEE, Daejeon-si (KR); Eui-Suk JUNG, Daejeon-si (KR); Sang-Soo LEE, Daejeon-si (KR)

(72) Inventors: Sil-Gu MUN, Daejeon-si (KR); Jeong-Sik CHO, Daejeon-si (KR); Eun-Gu LEE, Daejeon-si (KR); Eui-Suk JUNG, Daejeon-si (KR); Sang-Soo LEE, Daejeon-si (KR)

(73) Assignee: Electronics and Telecommunications Research Institute, Daejeon (KR)

(21) Appl. No.: 13/618,955

(22) Filed: Sep. 14, 2012

(30) Foreign Application Priority Data
Feb. 29, 2012 (KR) 10-2012-0021395

(51) Int. Cl. G02B 6/34

(52) U.S. Cl. 385/37

(57) ABSTRACT

An Arrayed Waveguide Grating Router (AWGR) for wavelength multiplexing and demultiplexing is provided. According to an aspect, by generating phase differences of a plurality of received optical signals through an arrayed wavelength in which a plurality of waveguides having a predetermined length difference with respect to each other are arranged, and then coupling the optical signals with the different phase differences, wavelength multiplexing and wavelength demultiplexing are simultaneously performed using the maximum constructive interference and/or destructive interference effect of optical signals.

### CROSS-REFERENCE TO RELATED APPLICATION

This application claims the benefit under 35 U.S.C. §119(a) of Korean Patent Application No. 10-2012-0021395, filed on Feb. 29, 2012, the entire disclosure of which is incorporated herein by reference for all purposes.

### BACKGROUND

1. Field

The following description relates to wavelength multiplexing and demultiplexing, and more particularly, to an Arrayed Wavelength Grating Router (AWGR) for wavelength multiplexing and demultiplexing.

2. Description of the Related Art

An optical communication system based on wavelength multiplexing needs to monitor the quality of signals carried on each wavelength channel. For monitoring the quality of signals, it is necessary to separate individual channels from a wavelength multiplexed signal. One among methods of separating channels from a wavelength multiplexed signal is a method of extracting a part of optical power from a wavelength multiplexed signal, to input the extracted power to a demultiplexing device, and then to monitor each signal output from the demultiplexing device.

Specifically, for demultiplexing, a method of connecting a multiplexing device in a reverse direction can be used. However, using two multiplexing devices increases cost and requires a wide system space. If a single device can perform both wavelength multiplexing and wavelength demultiplexing, cost saving and high space efficiency can be achieved.

### SUMMARY

The following description relates to an Arrayed Waveguide Grating Router (AWGR) for wavelength multiplexing and demultiplexing, which causes no wavelength overlap without using a higher grating order.

In one general aspect, there is provided an Arrayed Waveguide Grating Router (AWGR) for wavelength multiplexing and demultiplexing, including: a plurality of input channel waveguides configured to receive a plurality of optical signals; an arrayed waveguide including a plurality of waveguides configured to be arranged with a constant length difference with respect to each other so as to generate phase differences between the optical signals received from the input channel waveguides; and a plurality of output channel waveguides configured to couple a plurality of optical signals output from the plurality of waveguides arranged in the arrayed waveguide, and to output the coupled optical signals.

According to another aspect, the AWGR may receive a wavelength multiplexed optical signal through a predetermined input channel waveguide of the plurality of input channel waveguides, convert the wavelength multiplexed optical signal into a plurality of optical signals having predetermined phase differences with respect to each other, through the plurality of waveguides arranged in the arrayed waveguide, and output different wavelengths of optical signals, respectively, through the plurality of output channel waveguides, using a maximum constructive interference and destructive interference effect of optical signals output from the waveguides arranged in the arrayed waveguide, thereby performing wavelength demultiplexing.

According to another aspect, the AWGR may receive different wavelengths of optical signals through the plurality of input channel waveguides, respectively, convert the different wavelengths of optical signals into a plurality of optical signals having predetermined phase differences with respect to each other, through the plurality of waveguides arranged in the arrayed waveguide, and output an optical signal to which all wavelengths of the optical signals are maximally coupled, through one of the plurality of output channel waveguides, using a maximum constructive interference effect of optical signals output from the plurality of waveguides arranged in the arrayed waveguide, thereby performing wavelength multiplexing.

Other features and aspects will be apparent from the following detailed description, the drawings, and the claims.

### BRIEF DESCRIPTION OF THE DRAWINGS

FIG. 1 is a diagram illustrating an example of an Arrayed Waveguide Grating Router (AWGR) for wavelength multiplexing and demultiplexing.

FIG. 2 is a view for explaining wavelength multiplexing/demultiplexing of the AWGR when the AWGR is configured to have 2N+1 channels or more.

FIG. 3 is a view for explaining an example where wavelength multiplexing and demultiplexing are applied to channels corresponding to lower wavelengths with respect to a center channel.

FIG. 4 is a view for explaining an example where the AWGR monitors the wavelength of a wavelength multiplexed optical signal when the AWGR is configured to have 2N+1 channels.

FIG. 5 is a view for explaining an example where the AWGR monitors the wavelength of a wavelength multiplexed optical signal when a reference wavelength is shifted.

FIG. 6 shows an example of a cyclic characteristic of a transmission spectrum with respect to a pair of input and output channels.

FIG. 7 shows an example of an optical spectrum output from the AWGR when the AWGR is configured to have 2N+1 channels.

FIG. 8 shows an example of an optical spectrum output from the AWGR when a reference wavelength is shifted.

FIG. 9 is a view for explaining an example where the AWGR performs wavelength multiplexing on two or more bands while monitoring the bands.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

For wavelength multiplexing and demultiplexing, various technologies, such Fiber Bragg Grating, Thin Film Filter, etc., have been used. However, recently, a wavelength multiplexing and demultiplexing device based on planner waveguide technology is attracting attention since it can use multiples channels, be small-sized, and also operate stably.

As a method for performing wavelength multiplexing and demultiplexing simultaneously using a single planer wavelength-based device, a method of using a higher grating order of Arrayed Waveguide Grating (AWG) has been proposed. The method can be implemented only by changing the design of AWG.

However, when high-order diffracted signals pass back and forth through waveguide paths, signal overlapping with main signals occurs, which causes crosstalk. Furthermore, in order to use a high order, it is necessary to reduce a Free Spectral Range (FSR) or increase the sizes of slab waveguides.

However, a narrow FSR also narrows an acceptable wavelength band, resulting in a reduction of the number of available channels. Meanwhile, increasing the sizes of slab waveguides inevitably increases a device size, consequently requiring greater accuracy in design.

For these reasons, an Arrayed Wavelength Grating Router (AWGR) for wavelength multiplexing and demultiplexing has been proposed. The AWGR has a many-to-many input/output structure, unlike the AWG having a one-to-many or many-to-one structure.

If the AWGR receives different wavelengths of signals through a plurality of input channel waveguides, the AWGR multiplexes the different wavelengths of signals and outputs the wavelength multiplexed signal to one of a plurality of output channel waveguides. Meanwhile, if the AWGR receives a wavelength multiplexed signal into which a plurality of wavelengths have been multiplexed through one of the plurality of input channel waveguides, the AWGR demultiplexes the wavelength multiplexed signal and outputs different wavelengths of signals to the plurality of output channel waveguides, respectively.

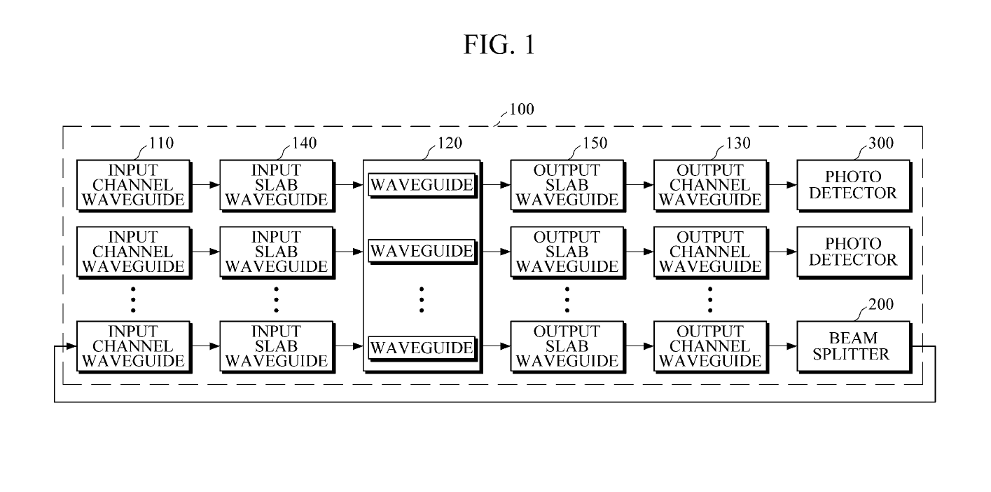

FIG. 1 is a diagram illustrating an example of an AWGR 100 for wavelength multiplexing and demultiplexing. Referring to FIG. 1, the AWGR 100 may include a plurality of input channel waveguides 110, an arrayed waveguide 120, and a plurality of output channel waveguides 130.

The input channel waveguides 110 receive optical signals. If a wavelength multiplexed optical signal is received through a specific input channel waveguide of the input channel waveguides 110, wavelength demultiplexing may be performed, and if different wavelengths of optical signals are received through the input channel waveguides 110, respectively, wavelength multiplexing may be performed.

The arrayed waveguide 120 consists of a plurality of waveguides that are arranged with a constant length difference ΔL with respect to each other so as to generate phase differences between optical signals received from the input channel waveguides 110. Since optical interference depends on the length of an optical path, a refractive index of medium, the wavelength or frequency of light, etc., the arrayed waveguide 120 where a plurality of waveguides are arranged with a constant length difference ΔL with respect to each other is used to change the lengths of optical paths.

In the case of performing wavelength demultiplexing, the waveguides with the constant length difference ΔL, arranged in the arrayed waveguide 120, convert different wavelengths of an optical signal received from one of the input channel waveguides 110 into a plurality of optical signals having predetermined phase differences with respect to each other.

In the case of performing wavelength multiplexing, the waveguides with the constant length difference ΔL, arranged in the arrayed waveguide 120, convert optical signals having different wavelengths and being received from a plurality of the input channel waveguides 110 into a plurality of optical signals having predetermined phase differences with respect to each other.

The output channel waveguides 130 couple the optical signals output from the waveguides arranged in the arrayed waveguide 120, and output the results of the coupling. If wavelength demultiplexing is performed, due to the maximum constructive interference and destructive interference effect of optical signals output from the waveguides arranged in the arrayed waveguide 120, the output channel waveguides 130 output different wavelengths of optical signals, respectively.

That is, when wavelength demultiplexing is performed, optical signals output from the waveguides arranged in the arrayed waveguide 120 are wavelength-demultiplexed through the plurality of output channel waveguides 130 and output.

Meanwhile, when wavelength multiplexing is performed, due to the maximum constructive interference effect of optical signals output from the waveguides arranged in the arrayed waveguide 120, an optical signal to which all wavelengths of the optical signals are maximally coupled is output through one of the output channel waveguides 130.

That is, when wavelength multiplexing is performed, optical signals output from the waveguides arranged in the arrayed waveguide 120 are wavelength-multiplexed through a specific one of the output channel waveguides 130 and output.

If M waveguides are arranged with a constant length difference ΔL in the arrayed waveguide 120 and the same wavelength λ of light is incident to the individual waveguides of the arrayed waveguide 120, the waveguides of the arrayed waveguide 120 may output M optical signals having the same wavelength λ or a constant phase difference (=neff*ΔL/λ) with respect to each other, wherein neff is an effective refractive index of the arrayed waveguide 120.

The M optical signals output from the waveguides of the arrayed waveguide 120 produce interference in front of the output channel waveguides 130. If light that has been input to a p-th (0≦p≦N) waveguide of the input channel waveguides 110 and reached a r-th (0≦r≦N) waveguide of the output channel waveguides 130 via a q-th (0≦q≦M) waveguide of the arrayed waveguide 120 has the same phase as light that has been input to the p-th waveguide of the input channel waveguide 110 and reached the r-th waveguide of the output channel waveguides 130 via a q′-th (0≦q′≦M, q≠q′) waveguide of the arrayed waveguide 120, the two light beams are coupled and input to the r-th output channel waveguide 130 with occurrence of maximum constructive interference.

However, if the two light beams are out of phase, destructive interference occurs so that the light beams are coupled and input to the r-th output channel waveguide 130 with weakened power.

Since the number of transfer paths of light from the p-th input channel waveguide 110 to the r-th output channel waveguide 130 is M, M light beams are totally interfered with each other and then coupled and input to the r-th output channel waveguide 130.

Such interference depends on factors such as the length of an optical path, a refractive index of medium, the wavelength (frequency) of light, etc. By using dependency of is interference on the wavelength of light among the above-mentioned factors, it is possible to enable a specific wavelength to produce maximum constructive interference at the r-th output channel waveguide 130.

That is, by varying the lengths of the waveguides of the arrayed waveguide 120 to adjust the phase difference of light such that the intensity of light that is input to each output channel waveguide depends on the wavelength of the light, the N output channel waveguides 130 may separate N different wavelengths of light beams from each other so that they can be coupled at their maximum intensities. The process is wavelength demultiplexing. Here, the wavelength difference between N input light beams is generally set to a constant value Δλ.

Meanwhile, wavelength multiplexing is reversible with wavelength demultiplexing. If N different wavelengths of light beams are input to N input channel waveguides, respectively, the light beams are coupled at their maximum intensities in the output channel waveguides 130. The process is wavelength multiplexing.

Meanwhile, according to another aspect, the AWGR 100 for wavelength multiplexing and demultiplexing may further include a plurality of input slab waveguides 140.

The input slab waveguides 140 correspond to a free propagation region, and act to spatially free-propagate optical signals output from the input channel waveguides 1110 to the arrayed waveguide 120.

Meanwhile, according to another aspect, the AWGR 100 may further include a plurality of output slab waveguides 150.

The output slab waveguides 150 also correspond to a free propagation region, and act to spatially propagate optical signals output from the waveguides arranged in the arrayed waveguide 120 to the output channel waveguides 130.

The AWGR 100 illustrated in FIG. 1 has a structure where a demultiplexing structure (that is, a one-to-many structure) for AWR is combined with a multiplexing structure (that is, a many-to-one structure) for AWG.

If a wavelength multiplexed optical signal is input to a specific input channel waveguide of the input channel waveguides 110 of the AWGR 100, the wavelength multiplexed optical signal is demultiplexed, and the demultiplexed optical signals are respectively coupled in the output channel waveguides 130, and then output.

Meanwhile, if a plurality of optical signals having different wavelengths are input to the input channel waveguides 110, the optical signals are multiplexed, and the multiplexed optical signal is output through a specific output channel waveguide of the output channel waveguides 130.

In this way, since wavelength multiplexing and demultiplexing can be performed simultaneously through a single device, it is possible to save a cost and space in an optical communication system.

When wavelength demultiplexing or wavelength multiplexing is performed, if an input/output channel waveguide corresponding to a N/2-th or (N/2+1)-th (when N is an even number) waveguide or a (N+1)/2-th (when N is an odd number) waveguide of the N input/output channel waveguides is selected as a specific input/output channel waveguide for multiplexing and/or demultiplexing, that is, if a waveguide located at or near the center of the N input/output channel waveguides is selected as a specific input/output channel waveguide for multiplexing and/or demultiplexing, wavelength overlap or crosstalk may occur at the optical wavelength of the center input/output channel waveguide.

In this case, if wavelength multiplexing and wavelength demultiplexing are performed simultaneously, the center output channel waveguide that outputs a multiplexed optical signal becomes identical to the center input channel waveguide that receives a multiplexed optical signal for demultiplexing.

In this case, a wavelength corresponding to a specific channel cannot be used. In order to overcome this problem, an optical circulator, an optical coupler, an optical isolator, etc. may be used for a center channel. However, addition of these components deteriorates the characteristics of the center channel.

The reason that wavelength overlap or crosstalk occurs is because wavelengths corresponding to the center input and output channel waveguides are set to a reference wavelength when the AWGR 100 is designed.

When the AWGR 100 for wavelength multiplexing and demultiplexing is implemented, a phase matching condition can be expressed as Equation, below:

nsδpᵢₙ+neff*ΔL+nsδrₒᵤₜ=k*λ

where ns represents refractive indexes of input and output slab waveguides, neff is an effective refractive index of the arrayed waveguide 120, spin is a difference in optical path until light output from the p-th input channel waveguide reaches two neighboring waveguides of the arrayed waveguide 120, grout is a difference in optical path until light output from two neighboring waveguides of the arrayed waveguide 120 reaches the r-th output channel waveguide, ΔL is a difference in length between two neighboring waveguides of the arrayed waveguide 120, and λ is the wavelength of light.

If a reference wavelength is λ_{ef}, wavelength overlap or crosstalk will occur if the reference wavelength λ_{ref} of the AWGR 100 is set to a wavelength λ_{c} of a center input/output channel waveguide, that is, a N/2-th input/output channel waveguide.

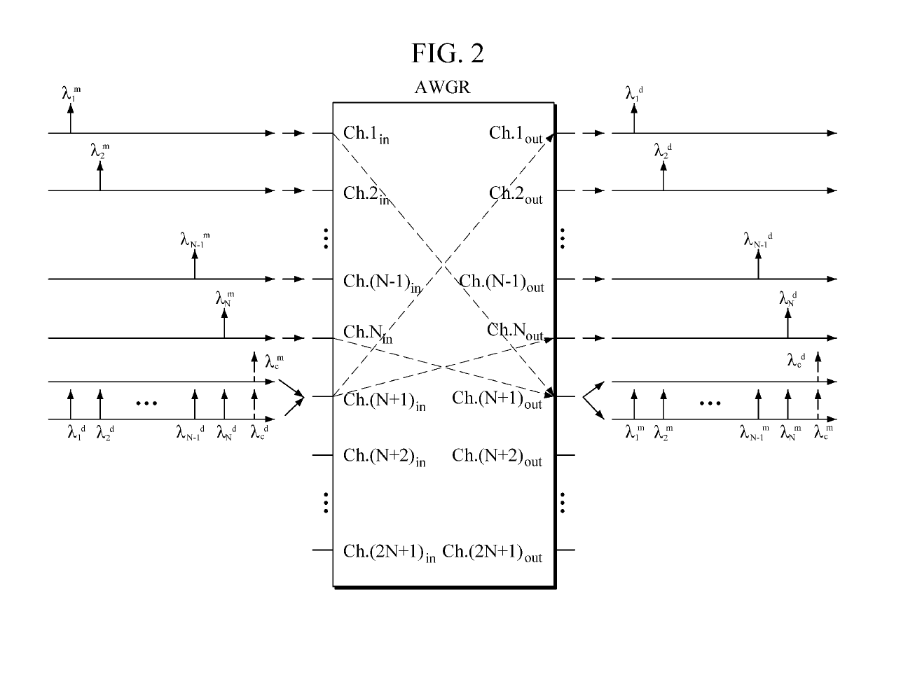

In order to perform wavelength multiplexing and wavelength demultiplexing is simultaneously without causing wavelength overlap or crosstalk, an AWGR for wavelength multiplexing and demultiplexing is designed in which the numbers of input and output channel waveguides each is 2N+1 or more and a FSR is (2N+1)*Δλ or more, as illustrated in FIG. 2.

Also, it is necessary to use a center input channel waveguide in which wavelength overlap may occur, that is, a (N+1)-th input channel waveguide as an input only for wavelength demultiplexing, not for wavelength multiplexing.

Likewise, it is also necessary to use a center output channel waveguide in which wavelength overlap may occur, that is, a (N+1)-th output channel waveguide as an output only for wavelength multiplexing, not for wavelength demultiplexing.

In this way, by allocating neither input signals for wavelength multiplexing nor output signals for wavelength demultiplexing to the wavelengths λ_{c}^{m} and λ_{c}^{d} of the center input and output channel waveguides, wavelength overlap may be prevented. In FIG. 2, λ_{c}^{m} and λ_{c}^{d} represent no real optical signals, but virtual signals provided for describing wavelength multiplexing and wavelength demultiplexing.

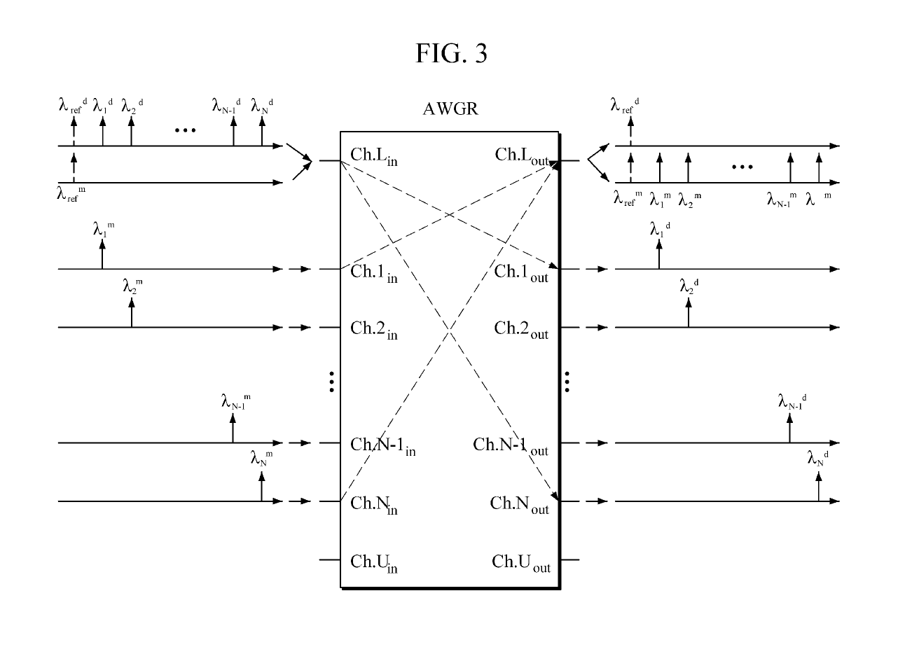

FIG. 3 is a view for explaining an example where wavelength multiplexing and demultiplexing are applied to channels Ch.1 through Ch.N corresponding to lower wavelengths with respect to the center input and output channel waveguides (that is, the (N+1)-th input and output channel waveguides). Meanwhile, the following description may be applied in the same manner to an example where N different wavelengths of signals are wavelength-multiplexed and wavelength-demultiplexed using channels Ch.(N+2) through Ch.(2N+1) corresponding to higher wavelengths with respect to the center input and output channel waveguides (that is, the (N+1)-th input and output channel waveguides).

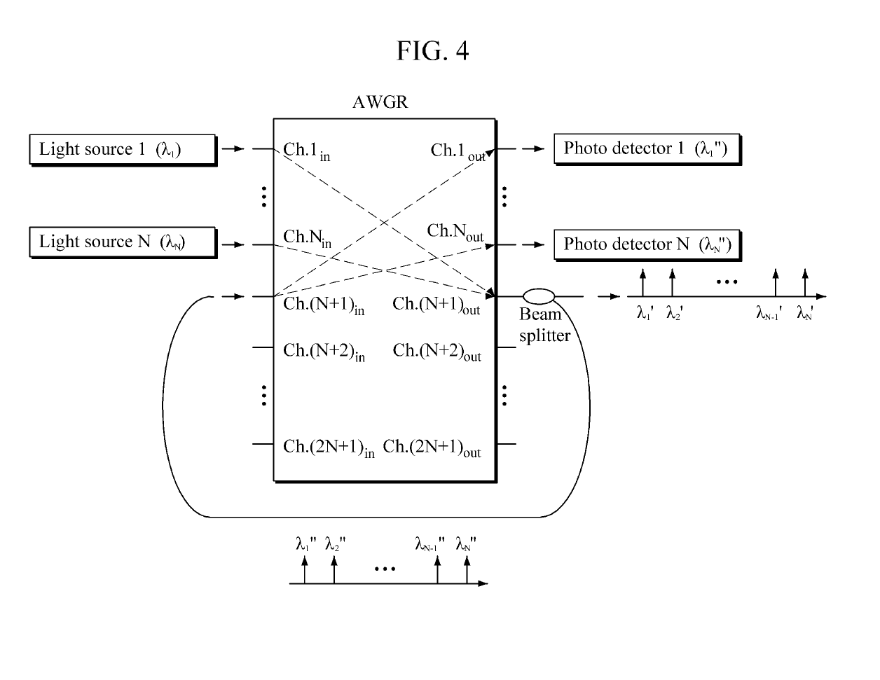

FIG. 4 is a view for explaining an example where the AWGR 100 monitors the is wavelength of a wavelength multiplexed optical signal when the AWGR 100 is configured to have 2N+1 input channel waveguides and 2N+1 output channel waveguides. The intensity of light multiplexed and output by the center output channel waveguide (that is, the (N+1)-th output channel waveguide) is split by a beam splitter 200 to thereby be divided into two signals of λ₁ . . . λ_{N}′ and λ₁ . . . λ_{N}″.

Here, λ₁ . . . λ_{N}′ is a main optical signal of the wavelength-multiplexed light, and λ₁ . . . λ_{N}″ is a split signal for monitoring the wavelength of the corresponding optical signal. The signal λ₁ . . . λ_{N}″ is fed back to the center input channel waveguide, that is, the (N+1)-th input channel waveguide, and then demultiplexed. The demultiplexed signal for each wavelength is input to a photo detector 300 for monitoring, converted into an electrical signal, and then transferred to a circuit for channel monitoring and control.

The beam splitter 200 and/or a plurality of photo detectors (300 for each) may be integrated into the AWGR 100, or implemented as separated devices.

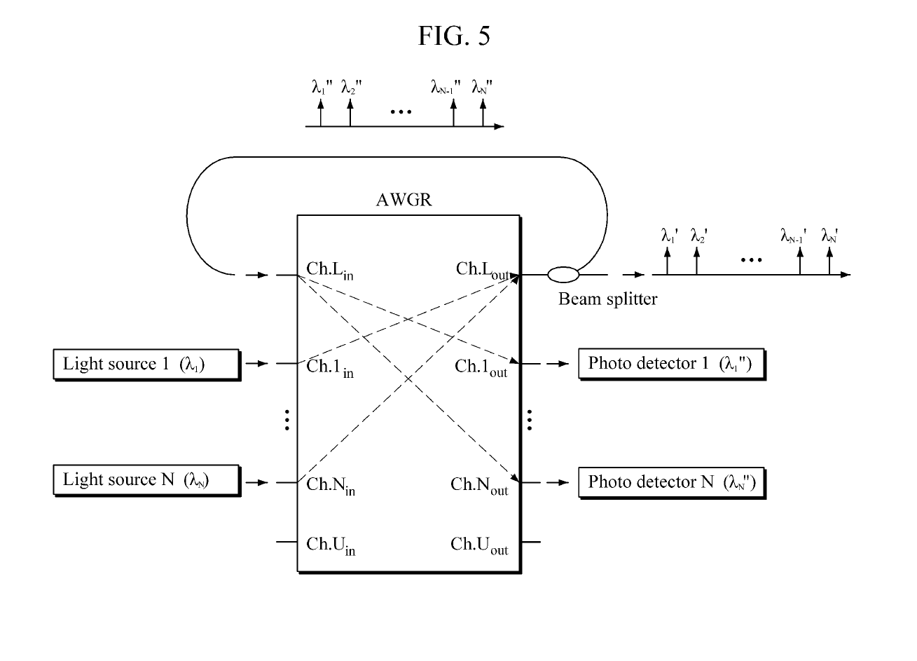

FIG. 5 is a view for explaining an example where the AWGR 100 monitors the wavelength of a wavelength multiplexed optical signal when a reference wavelength is shifted.

The intensity of light multiplexed and output by a specific output channel waveguide Ch.Lₒᵤₜ is split by the beam splitter 200 to thereby be divided into two signals of λ₁ . . . λ_{N}′ and λ₁ . . . X_{N}″. Here, λ₁ . . . λ_{N}′ is a main optical signal of the wavelength-multiplexed light, and λ₁ . . . λ_{N}″ is a split signal for monitoring the wavelength of the corresponding optical signal. The signal λ₁ . . . λ_{N}″ is fed back to the specific input channel waveguide Ch.Lᵢₙ and then demultiplexed.

The demultiplexed signal for each wavelength is input to the photo detector 300 for monitoring, converted into an electrical signal, and then transferred to a circuit for channel is monitoring and control. Accordingly, the AWGR 100 having N available channels can monitor C (C≦N) different wavelengths of signals.

Meanwhile, the AWGR 100 for wavelength multiplexing and demultiplexing may be applied to perform wavelength multiplexing and demultiplexing at two wavelength bands.

The AWGR 100 shows a characteristic in which a transmission spectrum increases in intensity at regular intervals with respect to a pair of input and output channels. This characteristic is called a cyclic characteristic. The regular interval is called a Free Spectral Range (FSR).

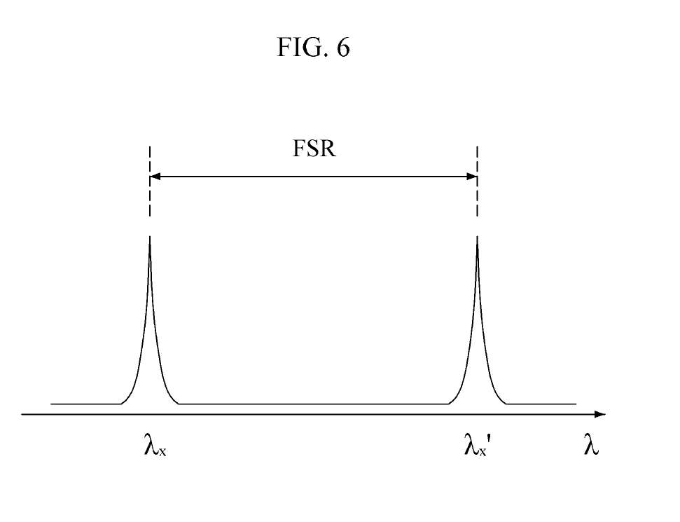

FIG. 6 shows an example of a cyclic characteristic of a transmission spectrum with respect to a pair of input and output channels. In the AWGR 100 for multiplexing and demultiplexing, a FSR is set to be much wider than a channel band in order to avoid wavelength overlap, however, it is general that a FSR is set to be identical to a wavelength band for wavelength routing.

For example, in the AWGR 100 which can accept 32 channels at a regular interval of 100 GHz, if a FSR of each channel is set to 3.2 THz, a wavelength cyclic characteristic is caused.

If the AWGR 100 has 2N+1 channels, the FSR is (2N+1)*Δλ or more. That is, a FSR exceeds about twice the number of channels. Meanwhile, if the number of channels is 2N+1+α, a FSR is (2N+1+α)*Δλ or more, wherein α is a natural number.

Meanwhile, if a reference wavelength is shifted in the AWGR 100 for wavelength multiplexing and demultiplexing, FSR>|λ_{Nd}−λ_{refd}| and FSR>|λ_{Nm}−λ_{refm}|, if λ_{ref}<λ₁. Meanwhile, if λ_{ref}>λ_{N}, FSR>|λ_{1d}−λ_{refd}| and FSR>|λₗₘ−λ_{refm}|.

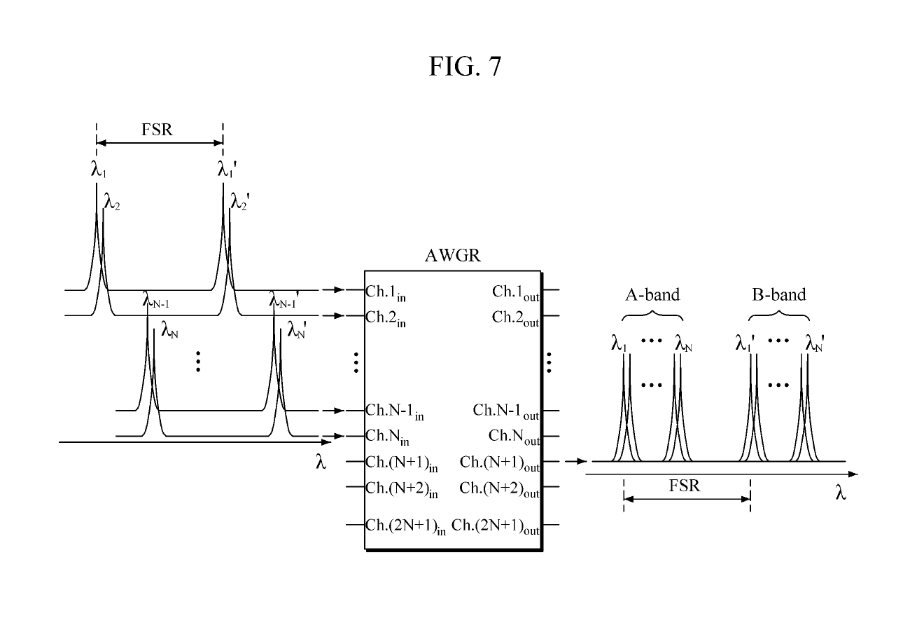

FIG. 7 shows an example of an optical spectrum that can be observed at an output channel Ch.(N+1)ₒᵤₜ when optical signals are wavelength-multiplexed using N channels from Ch.1ᵢₙ to Ch.Nᵢₙ in the AWGR 100 having 2N+1 channels.

In the optical spectrum shown in FIG. 7, if a group of neighboring wavelengths is referred to as A-band, and another group that appears due to the cyclic characteristic of the A-band is referred to as B-band, the AWGR 100 may wavelength-multiplex or wavelength-demultiplex the A-band or the B-band selectively.

Since the cyclic characteristic appears iteratively, it is possible to wavelength-multiplex or wavelength-demultiplex optical signals of a plurality of bands selectively. In view of the channel Ch.(N+1)ᵢₙ, the AWGR 100 may wavelength-multiplex or wavelength-demultiplex signals of a plurality of bands selectively.

Since wavelength multiplexing is reversible with wavelength demultiplexing, signals output from channels of Ch.1ₒᵤₜ through Ch.Nₒᵤₜ may be input to a channel Ch.(N+1)ᵢₙ. That is, signals of A-band may be wavelength-multiplexed and output to the channel Ch.(N+1)ₒᵤₜ, and signals of B-band may be wavelength-multiplexed and output to the channel Ch.(N+1)ᵢₙ.

By combining operations of such wavelength-multiplexing and wavelength-demultiplexing, various combinations, such as multiplexing of A-band and B-band, a combination of multiplexing of A-band with demultiplexing of B-band, a combination of demultiplexing of A-band with multiplexing of B-band, demultiplexing of A-band and B-band, etc., may be implemented.

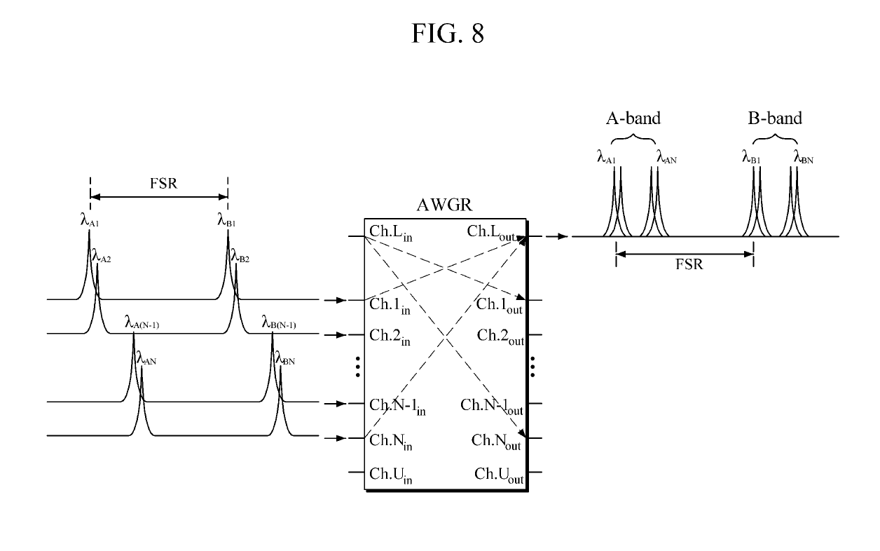

FIG. 8 shows an example of an optical spectrum that can be observed at the output channel Ch.Lₒᵤₜ when optical signals input to N input channels are wavelength-multiplexed in the AWGR 100 when a reference wavelength is shifted.

In the optical spectrum shown in FIG. 8, if a group of neighboring wavelengths is referred to as A-band, and another group that appears due to the cyclic characteristic of the A-band is referred to as B-band, the AWGR 100 may wavelength-multiplex or wavelength-demultiplex the A-band or the B-band selectively.

Since the cyclic characteristic appears iteratively, it is possible to wavelength-multiplex or wavelength-demultiplex optical signals of a plurality of bands selectively. In view of the channel Ch.Lᵢₙ, the AWGR 100 may wavelength-multiplex or wavelength-demultiplex signals of a plurality of bands selectively.

Since wavelength multiplexing is reversible with wavelength demultiplexing, signals output from channels of Ch.1ₒᵤₜ through Ch.Nₒᵤₜ may be input to a channel Ch.Lᵢₙ. That is, signals of A-band may be wavelength-multiplexed and output to the channel CH.Lₒᵤₜ, and signals of B-band may be wavelength-multiplexed and output to the channel Ch.Lᵢₙ.

By combining operations of such wavelength-multiplexing and wavelength-demultiplexing, various combinations, such as multiplexing of A-band and B-band, a combination of multiplexing of A-band with demultiplexing of B-band, a combination of demultiplexing of A-band with multiplexing of B-band, demultiplexing of A-band and B-band, etc., may be implemented.

If λ_{ref}>λ_{N}, Ch.Uᵢₙ and Ch.Uₒᵤₜ are used to perform various combinations of wavelength-multiplexing and wavelength-demultiplexing with respect to signals of different bands.

The AWGR 100 for wavelength multiplexing and demultiplexing also may be applied to the case of using C(C≦N) different wavelengths of optical signals from among N wavelength channels that are available.

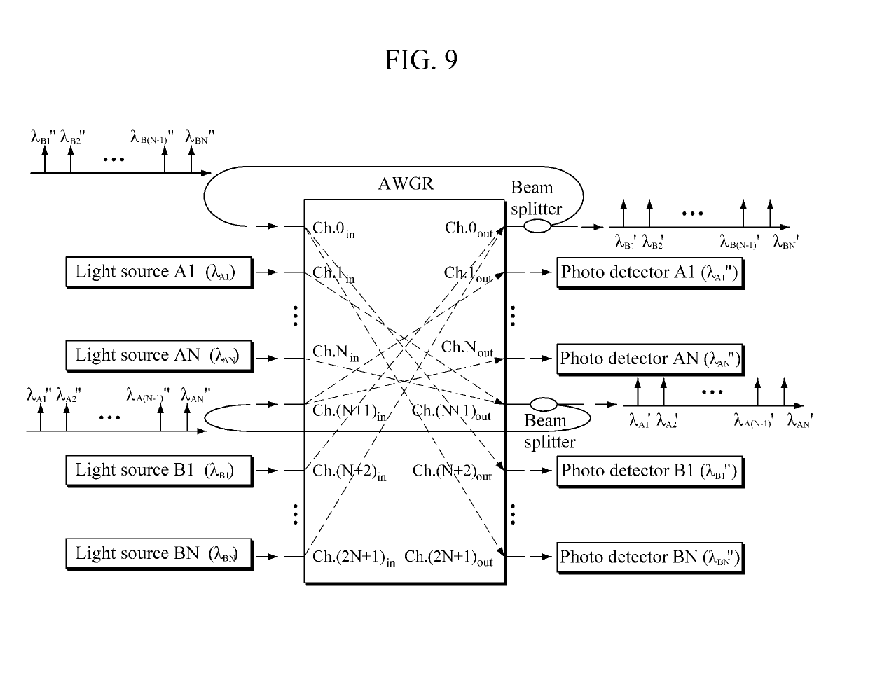

When the AWGR 100 has 2N+2 channels, it is possible to simultaneously perform wavelength multiplexing and wavelength monitoring with respect to two or more bands, as shown in FIG. 9. In this case, a channel Ch.0 of the AWGR 100 is used as an output channel for multiplexing optical signals allocated to channels from Ch.(N+2) to Ch.(2N+1), and as an input channel for demultiplexing an optical signal to be allocated to channels from Ch.(N+2) to Ch.(2N+1). In FIG. 9, A-band and B-band each may be a combination of the same wavelength is or may be a band with different wavelengths.

Therefore, as described above, since wavelength multiplexing and demultiplexing can be performed simultaneously by a single device, it is possible to save a cost and space in an optical communication system.

Furthermore, no wavelength overlap occurs without using a higher grating order, and effective demultiplexing for monitoring a wavelength multiplexed signal for each wavelength may be provided. Also, it is possible to multiplex and demultiplex two different wavelengths of signals at the same time.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Arrayed Waveguide Grating Router (AWGR) for wavelength multiplexing and demultiplexing, comprising:
a plurality of input channel waveguides configured to receive a plurality of optical signals;
an arrayed waveguide including a plurality of waveguides configured to be arranged with a constant length difference with respect to each other so as to generate phase differences between the optical signals received from the input channel waveguides; and
a plurality of output channel waveguides configured to couple a plurality of optical signals output from the plurality of waveguides arranged in the arrayed waveguide, and to output the coupled optical signals.

2. The AWGR of claim 1, receiving a wavelength multiplexed optical signal through a predetermined input channel waveguide of the plurality of input channel waveguides

3. The AWGR of claim 2, wherein at least one optical signal output from the plurality of waveguides arranged in the arrayed waveguide is wavelength-demultiplexed through the plurality of output channel waveguides and then output.

4. The AWGR of claim 3, wherein the plurality of waveguides arranged in the arrayed waveguide convert the wavelength multiplexed optical signal received from the predetermined input channel waveguide into a plurality of optical signals having predetermined phase differences with respect to each other.

5. The AWGR of claim 4, wherein the plurality of output channel waveguides output different wavelengths of optical signals, respectively, using a maximum constructive interference and destructive interference effect of optical signals output from the waveguides arranged in the arrayed waveguide.

6. The AWGR of claim 1, receiving different wavelengths of optical signals through the plurality of input channel waveguides, respectively.

7. The AWGR of claim 6, wherein at least one optical signal output from the plurality of waveguides arranged in the arrayed waveguide is wavelength-multiplexed through a predetermined output channel waveguide of the plurality of output channel waveguides and then output.

8. The AWGR of claim 7, wherein the plurality of waveguides arranged with a constant length difference with respect to each other in the arrayed waveguide convert different wavelengths of optical signals received respectively from the plurality of input channel waveguides into a plurality of optical signals having predetermined phase differences with respect to each other.

9. The AWGR of claim 8, wherein an output channel waveguide of the plurality of output channel waveguides outputs an optical signal to which all wavelengths of the optical signals are maximally coupled, using a maximum constructive interference effect of optical signals output from the plurality of waveguides arranged in the arrayed waveguide.

10. The AWGR of claim 1, wherein there are 2N+1 or more of each of the input channel waveguides and the output channel waveguides, a Free Spectral Range (FSR) is (2N+1)*Δλ or more, wherein Δλ is a constant length difference between the plurality of waveguides arranged in the arrayed waveguide, a center input channel waveguide which is a (N+1)-th input channel waveguide of the plurality of input channel waveguides is used as an input only for wavelength demultiplexing, not for wavelength multiplexing, and a center output channel waveguide which is a (N+1)-th output channel waveguide of the plurality of output channel waveguides is used as an output only for wavelength multiplexing, not for wavelength demultiplexing.

11. The AWGR of claim 10, further comprising a beam splitter configured to split an intensity of an optical signal multiplexed and output through the center output channel waveguide, and to feed back the multiplexed optical signal whose intensity has been split to the is center input channel waveguide.

12. The AWGR of claim 11, further comprising a plurality of photo detectors configured to convert each wavelength of optical signal fed back to the center input channel waveguide via the beam splitter and then demultiplexed through the center input channel waveguide, into an electrical signal, thereby outputting a signal for monitoring and controlling a wavelength channel.

13. The AWGR of claim 1, further comprising a plurality of input slab waveguides configured to spatially free-propagate optical signals output from the plurality of input channel waveguides to the arrayed waveguide.

14. The AWGR of claim 1, further comprising a plurality of output slab waveguides configured to spatially free-propagate optical signals output from the plurality of waveguides arranged in the arrayed waveguide to the plurality of output channel waveguides.
